(19) United States
(12) Patent Application Publication
(10) Pub. No.: US 2021/0342864 A1
(43) Pub. Date: Nov. 4, 2021

(54) SYSTEM AND METHOD FOR EVALUATING BLACK-BOX RECOMMENDATION SYSTEMS IN INFOTAINMENT SYSTEMS

(71) Applicant: Robert Bosch GmbH, Stuttgart (DE)

(72) Inventors: Hyeongsik KIM, San Jose, CA (US); Monireh EBRAHIMI, Manhattan, KS (US); Lu ZHOU, Manhattan, KS (US)

(21) Appl. No.: 16/862,633

(22) Filed: Apr. 30, 2020

(51) Int. Cl. G06Q 30/02; G06Q 30/06

(52) U.S. Cl. CPC G06Q 30/0203; G06Q 30/0631

(57) ABSTRACT

A method of evaluating a recommendation system, including conducting an online survey including a questionnaire regarding preferences to receive answers from a plurality of participants, utilizing answers from the survey at a recommendation system, outputting a recommendation at the recommendation system for the participants, wherein the recommendation include a feedback option indicating a score for the recommendation, receiving the score associated with the recommendation, and sending the score to a behavioral log.

### TECHNICAL FIELD

The present disclosure relates to evaluating infotainment systems with recommendation features.

### BACKGROUND

Recommendation systems (“RS”) are gaining popularity in everyday technology, such as televisions, streaming devices, mobile devices, computers, tablets, and vehicle infotainment systems. The recommendation systems may provide users with convenience in driving situations when utilized in a vehicle infotainment system. While some recommendation systems may be white box or gray box systems, many are black box systems that are either difficult or impossible to understand the inner workings. This may be difficult to test or benchmark such systems utilizing metrics, especially for systems that are impossible to understand their internal workings.

### SUMMARY

According to one embodiment, a method of evaluating a recommendation system includes conducting an online survey including a questionnaire regarding preferences to receive answers from a plurality of participants, utilizing answers from the survey at a recommendation system, outputting a recommendation at the recommendation system for the participants, wherein the recommendation include a feedback option indicating a score for the recommendation, receiving the score associated with the recommendation, and sending the score to a behavioral log.

According to a second embodiment, a computer product includes instructions that when executed cause the computer to conduct a survey including a questionnaire regarding preferences to receive answers from a plurality of participants, create a user profile in response to the answers from the survey and utilizing the user profile at the recommendation system, utilizing answers from the survey at the recommendation system, and output a recommendation at the recommendation system for the participants, wherein the recommendation include a feedback option indicating a score for the recommendation. The computer may also include instructions to receive the score associated with the recommendation and sending the score to a behavioral log.

According to a third embodiment, a method of evaluating a recommendation system includes conducting a survey including a questionnaire regarding preferences that include answers from a plurality of participants, utilizing answers from the survey at a recommendation system, outputting a recommendation at the recommendation system for the participants, wherein the recommendation include a feedback option indicating a score for the recommendation. The method also includes receiving the score associated with the recommendation and sending the score to a behavioral log.

### BRIEF DESCRIPTION OF THE DRAWINGS

FIG. 1 is an embodiment of an offline evaluation workflow.

FIG. 2 is an embodiment of an online evaluation workflow.

FIG. 3 is a flowchart illustrating a collection of seed data and generated user profiles.

FIG. 4 is a flowchart illustrating a training of benchmark targets.

FIG. 5 is a flowchart illustrating various screen flows of training the benchmark targets.

FIG. 6 is a flowchart illustrating evaluating the benchmark targets and collecting feedback.

FIG. 7 is a flowchart of training and evaluating an infotainment system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Recommendation systems (RS) may have experienced popularity thanks to the emergence and success of online streaming services. They have gained some success in different platforms, including in vehicle infotainment (IVI) systems in vehicles. Recommendation systems are generally available and serve as commercial services, therefore its recommendation schemes may be essentially “black-box,” which means they are not known to the public as to how the recommendations is provided. As an example scenario, consider Android Auto, which is one of the infotainment systems developed by Google running on Android-based systems (e.g., Android-based mobile devices or the devices embedded in vehicles). While Android Auto may not have its own recommendation feature, it may provide the functionalities of re-routing the recommendation request to appropriate applications when users request it utilizing its connected media play applications such as Google Play Music. These applications may be known to utilize location knowledge to make recommendations to the participants, therefore benchmarking such systems may involve physical travels over many different places to benchmark the ability of recommendations on locations, which would typically take an enormous amount of resources, efforts, and time. This may pose a challenge when the systems need to be evaluated and benchmarked, since many available techniques for evaluations are only developed for testing “white-box” systems where their internals (e.g., algorithms) can be easily monitored and controlled. To tack such a challenge, there may be a need for a system and method of evaluating the black-box recommendation systems in IVIs. The method may include an offline evaluation framework that can test the RS using the composite events which may often arise in the IVIs. The method may also include a specialized AB testing process developed for testing the RSs in IVIs, which may utilize key components such as a test-bed framework that can provide fair testing environments and effectively collect the feedback from users and the type-based data generation system that can dynamically generate user-profiles and usage data.

However, unlike the conventional testing process, the online evaluation procedure may include two sub-processes which are conducted before the actual user study process. One of the sub-processes may be the preliminary survey that collect user data to construct base user models. The other sub-process may be the data instantiation/population process that generate potential usage patterns based on the base user models.

These two sub-processes may resolve the challenges evaluating recommendation systems. It may be impossible or difficult to directly control the internals of a recommendation scheme because they may be backbox system that are difficult or impossible to understand how the internal processes or algorithms related to the recommendation operate. One of the main concerns that arise is that it may not be possible to cover all the potentially possible scenarios of usages and recommendations from the target recommendation system. However, it may be challenging to enforce the participants (users) to try and test all the combinations of actions, considering the complexity of the infotainment systems and their recommendation systems. To tackle this problem, there may be a need to develop the method and system that can maximize the coverage of user studies. As a solution of this problem, a data population technique may be used that can generate various test-cases from initial base user models and further allows reducing the burden of participants as well as increasing the coverage of the evaluation. This may result in a quicker evaluation process of the recommendation system. The systems and methods described below may be implemented on a computer with a processor. The computer may be connected to the Internet or a remote server to communicate various data collected or input from participants or received from remote sources.

The overall flow may be similar to the conventional NB tests or NA tests. For example, the system may test an RS using the group A while another test may utilize test another RS using the group B with the same usage patterns, etc. Note that the figures below may only show one side as an example (i.e. either A or B). The evaluation may then be first conducted over (i) the same usage pattern used for training to confirm that the training has been done properly and then over another set of the patterns generated using the type-based data population to measure its accuracies, etc.

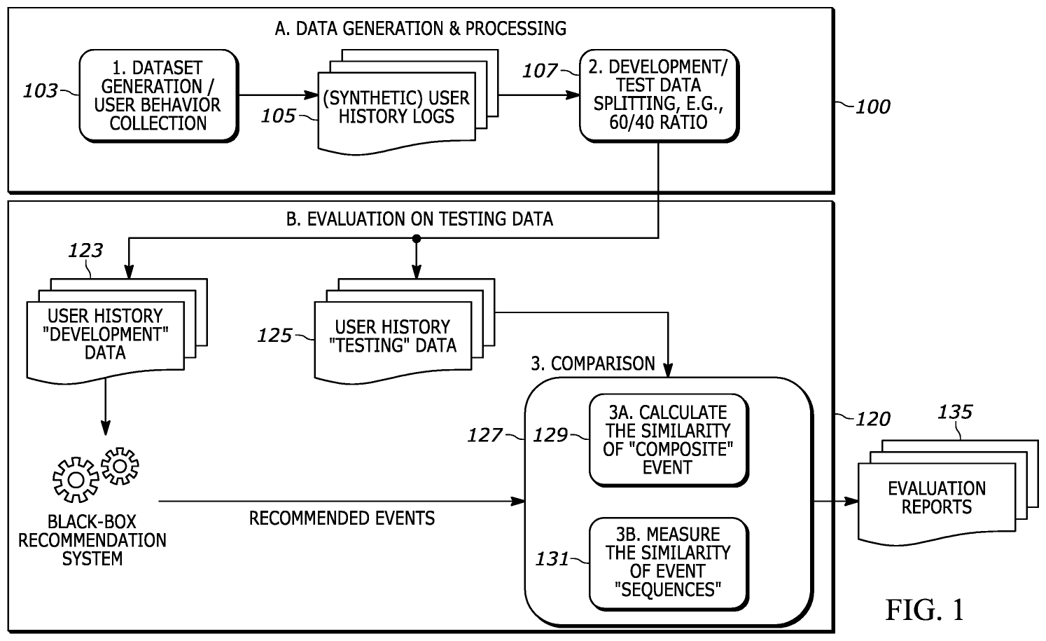

FIG. 1 is an embodiment of an offline evaluation flow diagram 100. At step 103, the evaluation may start with a dataset generation that may include user behavior collection. The evaluation may generate the history of user behaviors, such as 3000 users for 1 month. This may allow crowd sourcing of behaviors to develop some general trends. The dataset generation or collection processor may collect or generate time-stamped and geo-tagged history of user behaviors when interacting with the user interface of the system. The user behavior information will be collected or generated in the absence of the recommendation systems. Depending on the application the system is used for, the user behaviors of interest may vary from clicking the icons, the items, or the menus provided by the target RSs.

At step 105, the system may generate user history logs based on the information collected. The logs will include the user behavior data and all contextual information, as well as time stamps and geo-logging. In addition to user behavior data, depending on the application, all possible contextual information (e.g., inside/outside temperature, speed, and brake usage, etc). for the car infotainment recommendation system will be collected. The system may also contain a section that allows the user to provide its information including the user profile information, user preferences, schedules, and plans. This information may be further exploited as part of the context for describing the events/actions that have occurred in the system. The system may utilize feature-value pairs as a representation where the value representations are obtained in various ways including numerical or categorical representation of the values, pre-trained embedding using neural networks, and fuzzification. For example, for representation of the music songs one can use the pretrained embedding representation of each song instead of using the atomic names representation. This may allow the capture of the semantic similarity of the songs better and yet expect more diversity in the suggestions.

At step 107, the system may execute data splitting. The goal of the data splitting may be to hold out some part of the data (test data) to the system for case-based reasoning for the evaluation. The data may be split so that we can train the recommendation system on some part of the historical data and test the trained model on another part. Once the system has some user collected histories, the system can consider several possibilities for splitting data such as user-level partitioning, community-level partitioning, time-based session-level, or time-based event-level splitting where it can be decided which portion of the data should go for training the recommender and which part to the test set. In any case, the underlying assumption may be that the user prefers to get proactive suggestion notification for item/events that were selected in the absence of the recommender. At this stage, the system may mask some part of the test set and ask the recommendation system for a suggestion. The ratio of data that is split may be a 60/40 split, in one embodiment.

The evaluation and testing data portion 120 may be utilized in the offline evaluation. At step 123, the system may generate user history “development data.” This may include data utilized for clustering. This may include context and occurred event pairs. Such data may be fed into the black-box recommendation system. The black-box system may then output the recommended events for comparison. The recommended events may include songs, radio channels, HVAC configurations, etc. At step 125, the system may receive a portion of the split data into the user history “testing” data. The testing data may be unseen data that is utilized for the evaluation, e.g., context and correct event pairs.

At step 127, the system may compare and analyze the results from the testing data. At step 129, the system may calculate the similarity of the “composite” events. Once the data is ready, a comparison is done of the suggested action/event with the expected action/event in the test set. However, since the system may have the composite events, the system may not use the common accuracy metrics such as precision, recall, and f-measure. Instead, the system may calculate the composite event similarity (e.g., using Gower distance) and leverage it as performance assessment metric. Furthermore, to take ordering, time, and sequential property of the recommendations into account for the sake of evaluation, in addition to calculating the weighted distance of recommended events and expected events in isolated mode, the system may measure the similarity of event sequences in the offline data set with the suggested event sequences in each session at step 131. Various sequence similarity metrics, such as Dynamic Time Warping (DTW), may be used in such a step. DTW may be used to calculate the distance between two time series. It may be originally designed to give the optimal alignment between two time series, exploiting the temporal distortions between them. For each time step difference, we can use the standard metrics such as the Gower distance. At step 135, evaluation reports may be output to indicate the results of the comparison of the similarities between composite events and event sequences.

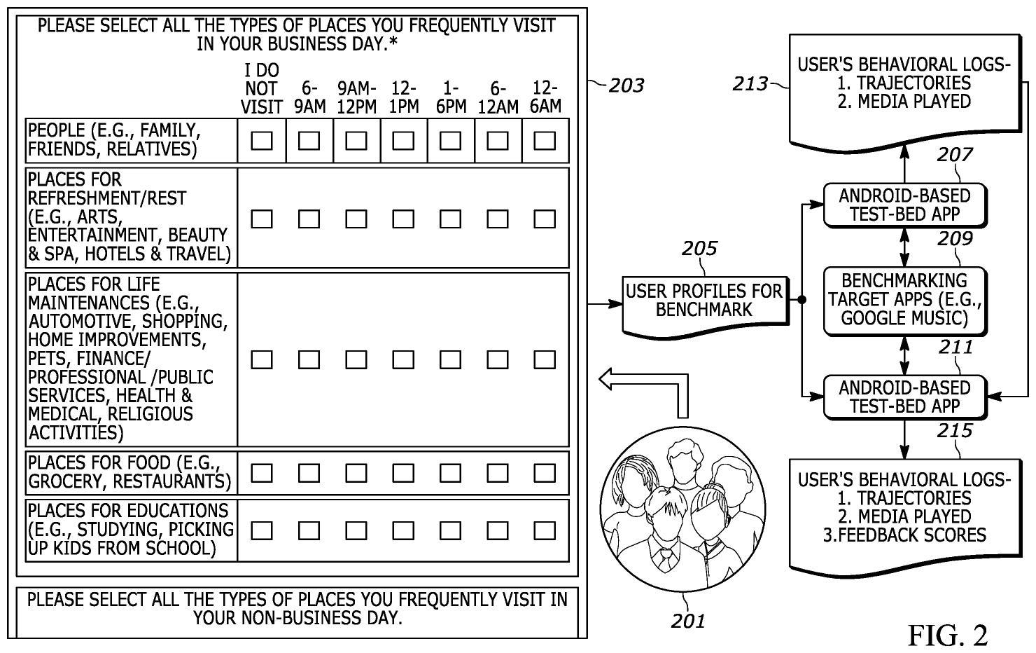

FIG. 2 is an embodiment of an online evaluation workflow. The online evaluation may include user studies that directly involve actual or potential users. The overall evaluation process may be built on conventional AB and A/A testing processes. Flow 201 indicates that test users may be gathered and aggregated to be utilized in the online evaluation. In step 201, the system may recruit participants who represent the users or potential users of infotainment systems that include recommendation systems. Any potential users who have an experience of driving can be the candidates the study, but many different types of recruiting strategies can be considered. For example, the method may consider focusing on selecting people who would be a representative of your eventual users/customers (e.g., people who can afford new vehicles, who want to buy new cars, and who are early-adopters, etc.). Among these people, the system can then select people from various groups evenly, e.g., people with different groups of ages and driving experiences. This may ensure that the participant pool is not skewed. The online evaluation may be an online survey or another form of evaluation. For example, certain applications or websites like SURVEY MONKEY may be utilized.

At step 203, the users may fill out a preliminary survey. The preliminary survey may have questions to gauge interests and preferences of the users. Before conducting actual user studies over the target recommendation systems in an infotainment system, a preliminary survey may be conducting regarding the patterns of travels, media preferences, media-listening behaviors of the participants, etc. While the system may utilize the data collected in other steps (e.g., the first step) of the evaluation process, it may be beneficial to specifically collect “base” data from the participants for generating synthetic travel patterns and media-listening patterns. Instead of directly asking users to use and test the recommendation systems, it may be beneficial to first investigate their general, abstract usage patterns using a “type-based” approach. Such data may be crowd-sourced to fit a participant in a group or type of usage pattern. The group or type may be for a specific type of preference (e.g., music, travel pattern, etc.), or may be based on several preferences.

In order to directly ask the preference the users (e.g., preference of actual songs to be played), the survey may ask users to provide their preferred “genres” instead (e.g., which of the following genres are the ones you would like to listen to while driving your vehicle). This may allow the genres of music to be used as the types representing a group of specific songs). To investigate the location-based recommendations of the system, the survey may need to ask the traveling patterns of the participants. In this case, the survey can ask the type of the locations (e.g., home, work, a place for rest, a place for educations, etc.), the routes preferred (highways, expressways, etc.}, and the time ranges preferred (e.g., 8:00 AM-10:00 AM) rather than asking and collect actual their traveling histories.

Similarly, the survey can collect information on the “types” of other activities or events that can arise from the usage of the RSs in an infotainment system etc., such as types/genres of the radio channels, people to call, climate settings, seat settings, etc. Eventually, the survey may collect and merge these selected types into a single file or storage unit called a “user-profile”, which summarizes the preference of a specific user. Such user-profiles can be expressed using any existing knowledge formats such as conventional key-value formats where key is the entry used in recommendation systems and the values are a list of types, e.g., {“music”=(“rock”, “pop”, “classical”} as JSON and/or more statistical/probabilistic data models also can be considered, etc.

The system may ask and collect their expectations and potential responses on the recommendation made by the target RS (i.e. information on implicit feedbacks) so that later the system can properly score and interpret the user ratings and their satisfaction. For example, the system may ask “What would a user would do if you found that the RS made the recommendations you would not like? (a) I would keep asking the recommendations, (b) I would try after some time passes, and (c) I would not ask the recommendation at all” or other such types of questions, responses, etc.”

Once the survey results are collected from the participants, the next step 205 may be to populate the simulated usage records of the target RSs in IVs based on the user profiles collected from the first preliminary survey and training the target RSs using the populated datasets. The user profiles may thus train the RS in the infotainment system of some high level tendencies of the user. In the next phase, the system may train the target RS at step 207. At step 209, the system may benchmark target apps. Some of the apps may be applications that are loaded on a mobile device (e.g., phone) that relate to the survey questions. For example, one application may be a music-based application like Google Music that provides recommendation for songs, albums, and playlists.

At step 213, the system may generate usage histories utilizing type-based data population. In this step, the types specified in the user-profiles are mapped back into actual instances, which is an inverse process of surveying the preference of users to generate actual user instance. For example, if the user listed his/her favorite genres of the music is “pop” and “alternative rock”, then the system can safely assume that the user would prefer to listen to the song in Top 100 music chart ranks of those genres, and thus the system may randomly pick 20 songs out of the top 100. It may also be possible that user may have more specific preferences and may not like all of them. Thus, the system can provide users with questions again whether there are any such genres, songs, albums, etc. that are not preferred and exclude them as needed.

At step 215, the system may create the behavioral logs. The system may utilize trajectories, media played, and feedback scores for the behavioral logs. For example, the system can consider generating potential trajectories as a part of testing location-based recommendation feature by selecting actual place of interests based on the types listed in the user profiles. For example, once scenario may have the user specific that he/she travels from “home” to “places for educations” at 7:30 am and the user also answered that he/she has a 4-year-old child. In that case, the system can generate trajectories from his/her home to nearby daycare institutions using several different combinations of routes. The system can also additionally ask users or other third-party reviewers whether such generated travel histories are plausible ones or not.

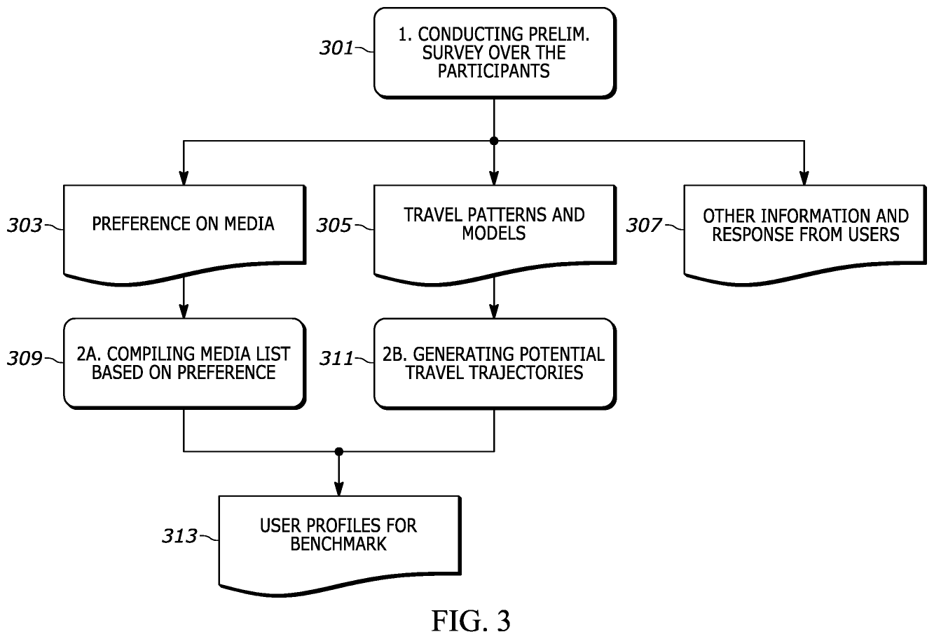

FIG. 3 is a flowchart illustrating a collection of seed data and generated user profiles. At step 301, the system may conduct the preliminary survey over various participants. In an alternative approach where conducting the preliminary survey may not be suitable or possible, the system can then consider conducting another survey that directly asks the schedules of users and builds user models or use the data from third-party apps or services.

At step 303, the system may collect information on their preference of media. For example, the system can ask questions such as “Can you let us know all the places you have visited for the past three days?”, “Can you tell us which routes you followed for visiting the places?” and “Can you also let us know which songs or radio channels you've listened to?” Additionally, the system can also ask their future travel patterns, e.g., “Can you share your schedules and places for the next three days”, etc. While this approach may limit the coverage of the user studies, it still allows conducting the user studies using the same methodologies and systems designed for an embodiment of the user study approach.

At step 305, the system will collect information related to travel patterns and models. The system may ask whether the user has frequently visited various categories of places over specific time periods. For example, the system may collect information on visiting patterns at educational places between 5-7 PM via a survey or collecting data. At step 307, the system may determine whether there are any other factors that matters affecting media-listening and usage behaviors, etc. This may include climate settings or other vehicle settings. Rather than waiting for such data to be collected from actual users traveling, a potential workaround is to utilize data which can be extracted from the third-party services or apps. For example, Google Maps provides the timeline feature which tracks the location and trajectories of users with timestamps. Other information, such as location data, can be extracted from the third-party applications. One can consider utilizing such a feature by downloading the travel records from the services, which can be used to generate the input files and the GPS logs for other benchmarking recommendation systems in infotainment systems.

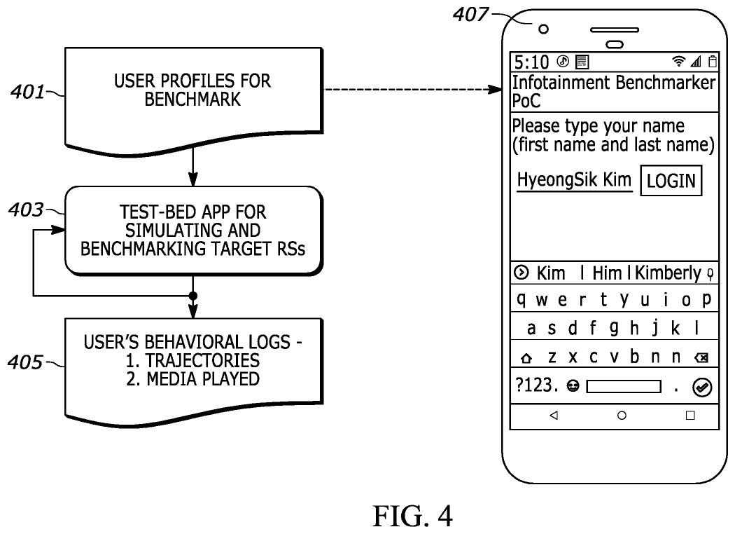

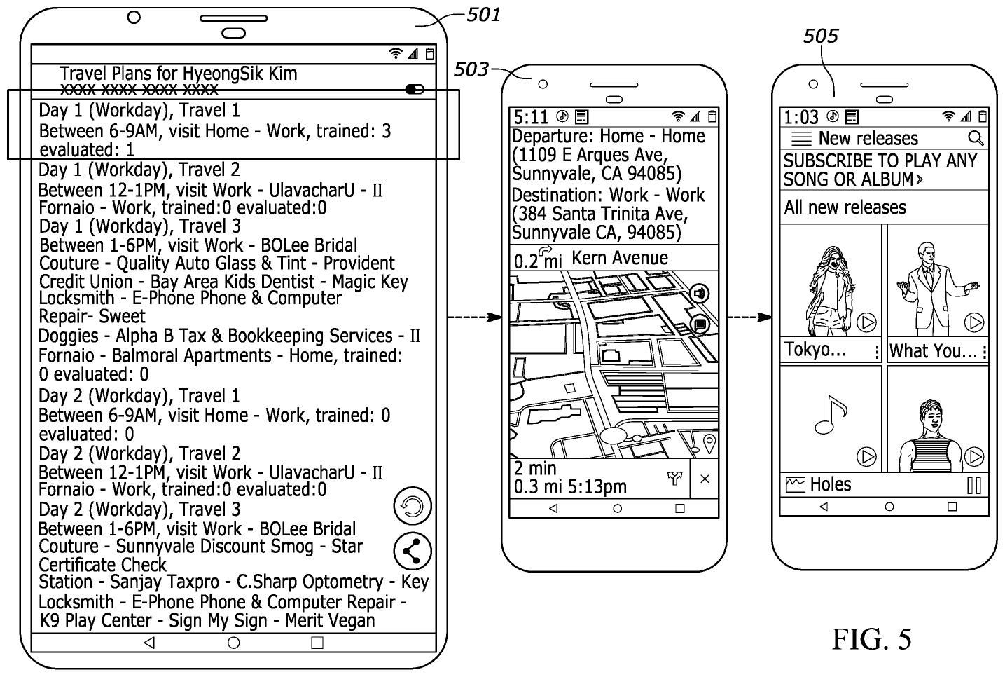

At step 309, the system may compile a media list based on preferences. In this way, the system may populate a set of plausible usage histories which consists of media listening behaviors, people called while driving, HVAC configurations adjusted, etc. For example, the system may prepare popular songs for each genre (e.g., top 10 songs) that may be utilized for benchmarking. This may be shown in more detail with respect to FIGS. 4-5.

At step 311, the system may determine if it is generating potential travel trajectories. The system will utilize the travel patterns surveyed and populate various travel trajectories (e.g., routes). Thus, for example, the system may populate three days of travel trajectories that are generated on test-bed apps or targeted systems. If the target systems support the feature a direct ingestion of the input data, the populated data can be directly fed into the target systems so that users can begin its studies over the target system. However, the data import feature may generally not be available for most black-box systems or there are no ways to directly access the inputs and outputs of these systems due to security and privacy concerns. To resolve this issue, the system may utilize or introduce the test-bed app which can provide the simulated environment for the target systems.

At step 313, the system may create the user profiles for benchmark. All of the seed data may be collected to generate input for the user profile data. The user profile data may thus collect the results of the survey and patterns recognized from the test bed app.

FIG. 4 is a flowchart illustrating a training of benchmark targets. The benchmark target may be a media based player, such as Google Music, Spotify, Apple Music, etc. At step 401, the system may create or identify a user profile for the benchmarking process to collect feedback. The user may be first asked to login so that the system can accordingly select and process matching user profiles from the internal database. The user may login with a username or identification ID that is utilized for the benchmarking. After logging in, the system may test-bed an app for simulating and benchmarking target RSs at step 403. The benchmarking target recommendation system may be, for example, Google Music. The system may let users observe navigations over trajectory and play media they want and repeat as needed.

The target apps can be other media apps for the commercial online music streaming services such as Pandora, Spotify, etc, which also can be executed on a infotainment system or operating system, such as Android Auto, Samsung Tizen, or Apple Carplay (iOS). In addition, other metrics such as timestamps or sensor values (e.g. accelerometers) used for recommendations can be similarly mimicked and used for training target RSs in the vehicle multimedia system.

At step 405, the system may create user's behavioral logs that shows, for example, navigation trajectories and media plays. The behavioral logs may also show various other patterns, such as climate preferences, windshield wiper settings, vehicle seating settings, etc. The behavioral logs that are produced may be used for training the other target RSs as well.

FIG. 5 is a flowchart illustrating various screen flows of training the benchmark targets. At step 501, the screen may display various travel plans for a user. The user can see the travel routes populated based on the user profiles. In one screen, there may be 6 different routes.

For example, on Day 1, the travel 1 is the first route. The system may emulate the travel from home to work. Next. The system may show the navigational user interface when the user clicks the travel link. As shown in screen 503, the system may then simulate the travel from home to work. The users can observe their simulated travels from their navigation interface. At screen 505, the system may then also users to listen to songs they often listen to. This may be done while they are following the route on the navigational interface. Thus while the navigation route is being displayed, the system may provide suggestion of music that the user may accept or reject. Based on the acceptance and rejection of each suggestion by the RS, the evaluation system will be training the targets.

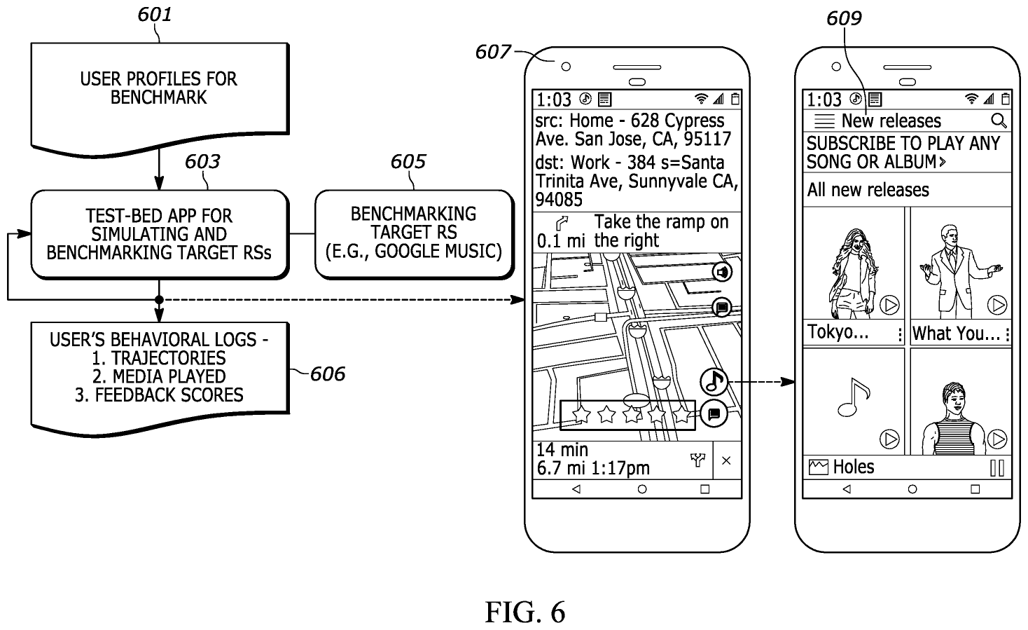

FIG. 6 is a flowchart illustrating evaluating the benchmark targets and collecting feedback. At this stage, the system may be ready to conduct the user study. The user study may be conducted over the same group of participants. This survey can be done using an on-line survey service or via offline person-to-person conversation sessions. At step 601, the system may create or identify a user profile for the benchmarking process to collect feedback. The evaluation steps may appear to be similar to the training steps, however, there is feedback provided during the evaluation. The user may login with a username or identification ID that is utilized for the benchmarking. After logging in, the system may testbed an app for simulating and benchmarking target RSs at step 603. The testbed app may mimic the travel activities based on the trajectories provided. For example, the process of training the Google Play Music may be utilized for the testbed app. The user profile data may contain the location of home and workplace of users and accordingly shows the traveling processing via its navigational interface provided by third-party services such as Google Maps and Mapbox, etc. The testbed app may continuously feed changing GPS coordinates to the operation system (e.g., Android Operating System), which may trick the application (e.g., the Google Play Music app) to think that users are physically in the middle of moving the destination and learn the preferences of users before conducting actual user studies. The feedback button may thus be utilized to provide feedback based on the recommendations. Based on the feedback, an evaluation report may be output.

In one portion of the user study process, the system may ask the recommendations to the target RSs under various scenarios and let users score the recommendation results to measure how satisfied users were on the recommendation results. The system may also check other issues as well from the second survey, e.g., coverage such as whether all songs have been played once at least, etc. Finally, the system may collect the results and begin analyzing processes using various analysis models, e.g., aggregate and compare the scores on various dimensions on user profiles, specific genres of media, or specific features of the RS or the vehicle system, etc.

FIG. 6 also illustrates an example scenario which tests location-based recommendation of the target RS, i.e. Google Play Music. In such a scenario, the navigational interface on the test-bed app may be displayed to mimic the scenario of driving along the routes synthesized without involving any physical travels. This may be accomplished by mimicking driving environments by showing navigational interfaces to participants, which may allow participants to be in the environment that they can make consistent and stable responses on recommendation results provided by recommendation systems in the vehicles. The test-bed app may contain the button to initiate the recommendation. Once the user clicks that button, the focus is automatically switched to the IVl's interface on playing media (i.e. Google Play Music now plays the recommended song using media intent on Android platform.). The user then comes back and rate the scores using star-shaped rating bars, numbers, thumbs up or thumbs, down, etc. While this is one embodiment, the similar structures of asking recommendations and recording feedback can be implemented on other available IVI platforms. The test-bed app may include a mobile device or bench system of a multimedia system, or a virtual reality or augmented reality system that utilizes virtual reality glasses and devices.

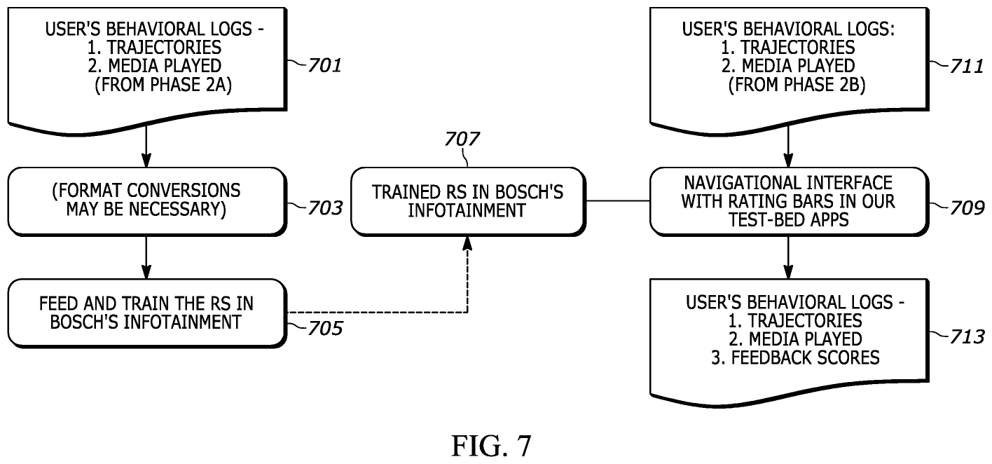

FIG. 7 is a flowchart of training and evaluating an infotainment system. A first portion of the system may be utilized for training the infotainment, while a second portion is related to collection of the infotainment. At step 701, the user's behavioral logs that may include the trajectories and media played by the user during a training phase. At step 703, the system may convert the format if necessary. At step 705, the system may feed and train the recommendation system in an infotainment system. The data may be feed and trained based on the specific user profile. The data may be fed via a remote server pushing data to an infotainment system that includes a wireless transceiver in communication with the server.

At step 707, the system may utilize the trained recommendation system in Bosch's infotainment system. Thus, the fed data may align with the user profile of the accompanied vehicle that the infotainment system is located in. The user profile may be associated with a key fob, mobile device, facial recognition, seat settings, or other information settings in the vehicle. Thus, the various devices or settings may be utilized to identify which user is present. Next the system may collect additional data. At step 709, the system may output a navigational interface with various rating bars in the test-bed application. The system may let users monitor their travel via the navigational interface and collect feedback. At step 713, the system may input the various data into the user's behavioral logs. Such data may include the driving trajectories, the media played, feedback scores, etc.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A method of evaluating a recommendation system of a vehicle multimedia system, comprising:
conducting an online survey including a questionnaire regarding preferences utilizing one or more computers;
receiving answers associated with the survey from a plurality of participants utilizing the one or more computers;
utilizing answers from the survey at the recommendation system of the vehicle multimedia system;
creating a user profile in response to the answers from the survey and utilizing the user profile at the recommendation system, wherein the user profile is associated with a key fob associated with the vehicle or a mobile device associated with the vehicle
outputting a recommendation at the recommendation system for the participants, wherein the recommendation include a feedback option indicating a score for the recommendation, wherein the recommendation system is trained utilizing the user profile;
receiving the score associated with the recommendation at a remote server; and
sending the score to a behavioral log at the remote server.

2. The method of claim 1, wherein the method includes weighting a similarity of recommended sequence of composite time-stamped events with a user's sequence of activities captured from the behavioral log.

3. The method of claim 1, wherein the behavioral log includes time-stamped events associated with a user's sequence of activities captured.

4. The method of claim 1, wherein the method includes outputting recommendations of music.

5. The method of claim 1, wherein the method includes outputting recommendations of route guidance.

6. (canceled)

7. (canceled)

8. The method of claim 1, wherein the method further includes conducting a user study utilizing a testbed application.

9. A method of evaluating a recommendation system of a vehicle multimedia system, comprising:
conducting a survey utilizing one or more computers, wherein the survey includes a questionnaire regarding preferences that include answers from a plurality of participants;
creating a user profile in response to the answers from the survey and utilizing the user profile at the recommendation system, wherein the user profile is associated with a key fob or mobile phone of a vehicle;
utilizing answers from the survey at the recommendation system of the vehicle multimedia system;
outputting a recommendation at the recommendation system for the participants, wherein the recommendation include a feedback option indicating a score for the recommendation and the recommendation system is trained utilizing the user profile;
receiving the score associated with the recommendation at a remote server; and
sending the score to a behavioral log at the remote server.

10. The method of claim 9, wherein the method includes categorizing the plurality of participants in a plurality of groups in response to the answers from the survey.

11. The method of claim 9, wherein the method includes outputting a second set of recommendations in response to the score.

12. The method of claim 9, wherein the recommendation system is in a vehicle multimedia system.

13. The method of claim 9, wherein outputting the recommendation is further in response to the user profile.

14. A computer-program product storing instructions on a non-transitory computer-readable medium of a computer which, when executed by the computer, cause the computer to:
conduct a survey utilizing one or more computers, wherein the survey includes a questionnaire regarding preferences that include answers from a plurality of participants;
creating a user profile in response to the answers from the survey and utilizing the user profile at the recommendation system, wherein the user profile is associated with a key fob or mobile phone of a vehicle;
utilize answers from the survey at a recommendation system of a vehicle multimedia system;
output a recommendation at the recommendation system for the participants, wherein the recommendation include a feedback option indicating a score for the recommendation and the recommendation system is trained utilizing the user profile;
receive the score associated with the recommendation; and
send the score to a behavioral log.

15. The computer-program product of claim 14, wherein the computer is further caused to request login information for the survey.

16. The computer-program product of claim 14, wherein the computer is further caused to compare the score across recommendations associated with genres of media.

17. The computer-program product of claim 14, wherein the computer is further caused to compare the score across recommendations associated with navigation route guidance.

18. The computer-program product of claim 14, wherein the computer is further caused to create a user profile in response to the answers from the survey and utilizing the user profile at the recommendation system.

19. The computer-program product of claim 14, wherein the survey is an offline survey.

20. The computer-program product of claim 14, wherein the computer is further caused to output recommendations of route guidance.
